(19) United States
(12) Patent Application Publication
(10) Pub. No.: US 2026/0024949 A1
(43) Pub. Date: Jan. 22, 2026

(54) ELECTRICAL CONNECTOR

(71) Applicant: LOTES CO., LTD, Keelung (TW)

(72) Inventors: Lun Cai, Guangzhou (CN); Kang Chen, Guangzhou (CN)

(21) Appl. No.: 19/023,873

(22) Filed: Jan. 16, 2025

(30) Foreign Application Priority Data
Jul. 22, 2024 (CN) 202410978836.2

(51) Int. Cl. H01R 13/6471; H01R 12/70; H01R 12/71; H01R 13/24; H01R 13/6596

(52) U.S. Cl. CPC H01R 13/6471; H01R 12/707; H01R 12/716; H01R 13/2492; H01R 13/6596

(57) ABSTRACT

An electrical connector includes a plurality of insertion assemblies located between two adjacent ground terminals. Each insertion assembly includes a metal sheet and an insulating block including a wave absorbing material. The metal sheet is electrically connected to the two ground terminals. The metal sheet and the ground terminals are in plate shapes, and plate surfaces of the metal sheet and the ground terminals are parallel to each other. A thickness of the insulating block is greater than a thickness of each of the ground terminals. Two side surfaces of the insulating block abut against the insulating body. In the present invention, the stub generated by the transmission path between the two ground terminals is shorter, which has good high frequency characteristics, and the whole insertion assemblies may be more easily assembled and fixed to the insulating body.

### CROSS-REFERENCE TO RELATED PATENT APPLICATION

This non-provisional application claims priority to and the benefit of, pursuant to 35 U.S.C. § 119 (a), patent application Serial No. CN202410978836.2, filed in China on Jul. 22, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to a high speed electrical connector.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The Chinese Patent No. CN202410234815.X discloses a high speed connector, which includes an insulating seat as well as a plurality of signal terminals and a plurality of ground terminals. The signal terminals and the ground terminals are arranged in a sequential order of -S-S-G-G-S-S-G-G-. To enhance the stability of the assembly structure of the ground terminals of the high speed connector, a grounding sheet is inserted between the two adjacent ground terminals. The grounding sheet is a metal sheet in a plate shape, and to stably fix the metal sheet in the insulating seat, the plate surface of the metal sheet is perpendicular to the plate surface of each ground terminal.

However, by performing the insertion of the metal sheet in the form of having its plate surface being perpendicular to the plate surface of each ground terminal, a portion of the metal sheet may pass excessively beyond the plate surface of each ground terminal, thereby generating a longer stub, such that the high frequency characteristics of the connector is deteriorated. Further, in the cited patent, only a single metal sheet is provided for insertion, and the metal sheet has a relatively thin thickness and a smaller cross-sectional area perpendicular to the insertion direction thereof, which means that an engaging slot for fixing the metal sheet has a smaller opening, which is not conducive to mass assembly of the metal sheet.

Therefore, a heretofore unaddressed need to design a new electrical connector exists in the art to address the aforementioned deficiencies and inadequacies.

### SUMMARY

In view of the deficiencies of the background technology, the present invention is directed to an electrical connector, in which the plate surface of the metal sheet inserted between two ground terminals and the plate surfaces of the ground terminals are parallel to each other. The metal sheet is fixedly provided with an insulating block including a wave absorbing material, and a thickness of the insulating block is greater than a thickness of each ground terminal, which is convenient for the overall assembly and fixing, and further improving the high frequency characteristics of the connector.

To achieve the foregoing objective, the present invention adopts the following technical solutions:

An electrical connector includes: an insulating body; a plurality of terminals, accommodated in the insulating body along a vertical direction, wherein the terminals comprise two signal terminals and two ground terminals arranged along a left-right direction, the two ground terminals are adjacent to each other, and the two ground terminals are located between the two signal terminals; and a plurality of insertion assemblies, wherein each of the insertion assemblies is located between the two ground terminals, each of the insertion assemblies comprises a metal sheet and an insulating block fixing the metal sheet, the metal sheet is electrically connected to the two ground terminals, the metal sheet and the ground terminals are in plate shapes, and plate surfaces of the metal sheet and the ground terminals are parallel to each other, the insulating block comprises a wave absorbing material, in a direction perpendicular to the plate surfaces of the ground terminals, a thickness of the insulating block is greater than a thickness of each of the ground terminals, and two side surfaces of the insulating block opposite to each other along the left-right direction abut against the insulating body.

In certain embodiments, in a direction perpendicular to a rear plate surface of the metal sheet, a distance of a rear plate surface of each of the ground terminals passing beyond the rear plate surface of the metal sheet is less than twice the thickness of each of the ground terminals, or a distance of the rear plate surface of the metal sheet passing beyond the rear plate surface of each of the ground terminals is less than twice the thickness of each of the ground terminals, or the rear plate surface of the metal sheet and the rear plate surface of each of the ground terminals are flush.

In certain embodiments, the metal sheet is provided with an opening slot and two interference portions, the two interference portions are respectively located at two sides of the opening slot, the insulating body has a protruding rib, and the protruding rib is accommodated in the opening slot and interferes with the interference portions.

In certain embodiments, the metal sheet comprises two retaining arms located at a left side and a right side thereof, each of the retaining arms comprises an abutting portion and a corresponding one of the interference portions located at a left side and a right side thereof, the abutting portion abuts against a corresponding one of the ground terminals, and the interference portions abut against the protruding rib.

In certain embodiments, each of the ground terminals comprises an upper protruding portion and a lower protruding portion, the upper protruding portion and the lower protruding portion respectively abut against the abutting portion, the upper protruding portion is located above the interference portions, and the lower protruding portion is located below the interference portions.

In certain embodiments, the insulating block is insert-molded to the metal sheet, the metal sheet comprises two abutting portions located at a left side and a right side thereof, each of the abutting portions comprises an abutting surface and a rear plate surface of the metal sheet perpendicular to and connected to the abutting surface, the abutting surface abuts against a corresponding one of the ground terminals, and a portion of the rear plate surface of the metal sheet connected to the abutting surface is exposed from the insulating block.

In certain embodiments, the metal sheet comprises a connecting portion exposed out of the insulating block, and the insertion assemblies are simultaneously assembled by a connecting member connected to the connecting portion.

In certain embodiments, each of the terminals comprises a soldering portion and a strip connecting portion, the soldering portion comprises a notch and soldering legs located at a left side and a right side of the notch, the soldering legs are soldered downward to a circuit board, the strip connecting portion protrudes downward into the notch, a bottom portion of the strip connecting portion is higher than a bottom portion of each of the soldering legs, a solder ball is accommodated in the notch, and the strip connecting portion abuts against the solder ball such that the solder ball passes downward beyond the bottom portion of each of the soldering legs.

An electrical connector includes: an insulating body; a plurality of terminals, accommodated in the insulating body, wherein the terminals are arranged in at least two rows along a front-rear direction, the terminals in each of the rows comprise two signal terminals and two ground terminals arranged along a left-right direction, the two ground terminals are adjacent to each other, and the two ground terminals are located between the two signal terminals; and a plurality of insertion assemblies separated from each other, accommodated in the insulating body, wherein each of the insertion assemblies is located between the two ground terminals and abuts against the two ground terminals, each of the insertion assemblies comprises a metal sheet and a lossy member fixed on the metal sheet, a thickness of each of the insertion assemblies is greater than a thickness of each of the ground terminals, and two side surfaces of each of the insertion assemblies opposite to each other along the left-right direction abut against the insulating body.

In certain embodiments, the metal sheet comprises a connecting portion exposed out of the lossy member, and the insertion assemblies are simultaneously assembled by a connecting member connected to the connecting portion.

In certain embodiments, the metal sheet is provided with an opening slot and two interference portions, the two interference portions are respectively located at two sides of the opening slot, the insulating body has a protruding rib, and the protruding rib is accommodated in the opening slot and interferes with the interference portions.

In certain embodiments, the metal sheet comprises two retaining arms located at a left side and a right side thereof, each of the retaining arms comprises an abutting portion and a corresponding one of the interference portions located at a left side and a right side thereof, the interference portions abut against the protruding rib, the abutting portion comprises an abutting surface and a rear plate surface of the metal sheet perpendicular to and connected to the abutting surface, each of the ground terminals comprises an upper protruding portion and a lower protruding portion, the upper protruding portion and the lower protruding portion respectively abut against the abutting portion, the upper protruding portion is located above the interference portions, and the lower protruding portion is located below the interference portions.

In certain embodiments, the lossy member is insert-molded to the metal sheet, the metal sheet comprises two abutting portions located at a left side and a right side thereof, each of the abutting portions comprises an abutting surface and a rear plate surface of the metal sheet perpendicular to and connected to the abutting surface, the abutting surface abuts against a corresponding one of the ground terminals, and a portion of the rear plate surface of the metal sheet connected to the abutting surface is exposed from the lossy member.

An electrical connector includes: an insulating body; a plurality of terminals, accommodated in the insulating body along a vertical direction, wherein the terminals comprise two signal terminals and two ground terminals arranged along a left-right direction, the two ground terminals are adjacent to each other, and the two ground terminals are located between the two signal terminals; and a plurality of insertion assemblies, located between the two ground terminals, wherein each of the insertion assemblies comprises a metal sheet and an insulating block fixing the metal sheet, in a direction perpendicular to plate surfaces of the ground terminals, a thickness of the insulating block is greater than a thickness of each of the ground terminals, two side surfaces of the insulating block opposite to each other along the left-right direction abut against the insulating body, the metal sheet abuts against the two ground terminals, the metal sheet and the ground terminals are in plate shapes, and in a direction perpendicular to a rear plate surface of the metal sheet, a distance of a rear plate surface of each of the ground terminals passing beyond the rear plate surface of the metal sheet is less than twice the thickness of each of the ground terminals, or a distance of the rear plate surface of the metal sheet passing beyond the rear plate surface of each of the ground terminals is less than twice the thickness of each of the ground terminals, or the rear plate surface of the metal sheet and the rear plate surface of each of the ground terminals are flush.

Compared to the related art, the electrical connector according to the present invention has the following beneficial effects:

The metal sheet and the two ground terminals are electrically connected, and the plate surface of the metal sheet and the plate surfaces of the ground terminals are parallel to each other. Normally, a plate member has its thickness to be less than its width. Thus, compared to the case where the plate surface of the metal sheet is perpendicular to the plate surfaces of the ground terminals, in the present invention, when the current flows from one ground terminal to the other ground terminal, the stub generated is shorter, and the high frequency characteristics become better. On the other hand, the insulating block includes the wave absorbing material, which may absorb the noise and reduce the crosstalk between the signal terminals, and by making the insulating block thicker, the cross-sections of the whole insertion assemblies perpendicular to the insertion direction are increased, thereby allowing the opening of each slot accommodating the corresponding insertion assembly to become larger, which is convenient to the assembly of the insertion assemblies. During assembly, the two side surfaces of the insulating block in the left-right direction may abut against and be fixed to the insulating body, and the whole insertion assemblies do not easily get loosened. More suitably, since the insulating block is not electrically conductive, it does not generate the stub when it becomes thicker.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of an electrical connector according to a first embodiment of the present invention.

FIG. 2 is a bottom view of the electrical connector according to the first embodiment of the present invention.

FIG. 3 is a schematic view of FIG. 2 after an insulating block is removed.

FIG. 4 is a sectional view of FIG. 2 along a line A-A.

FIG. 5 is a schematic view of a location B of FIG. 3 after being enlarged.

FIG. 6 is a schematic view of a location C of FIG. 4 after being enlarged.

FIG. 7 is a schematic view of insertion assemblies matching with two ground terminals.

FIG. 8 is a plain view of FIG. 7.

FIG. 9 is a schematic view of insertion assemblies prior to being inserted into an insulating body by a connecting member.

FIG. 10 is a sectional view of an electrical connector according to a second embodiment or a third embodiment of the present invention.

FIG. 11 is a chart of high frequency analysis of near end crosstalk of the first embodiment.

FIG. 12 is a chart of high frequency analysis of far end crosstalk of the first embodiment.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. As used herein, the terms “comprising”, “including”, “carrying”, “having”, “containing”, “involving”, and the like are to be understood to be open-ended, i.e., to mean including but not limited to.

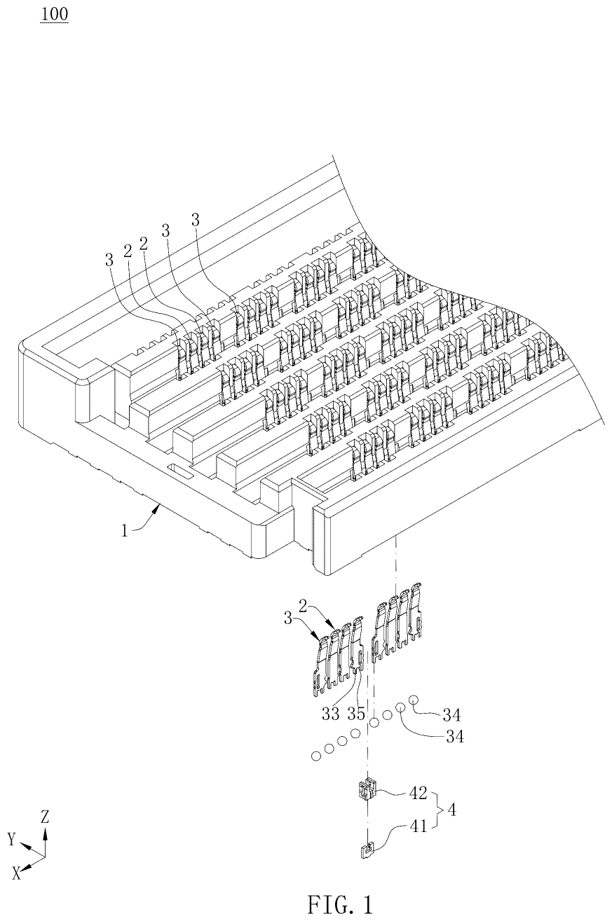

The description will be made as to the embodiments of the present invention in conjunction with the accompanying drawings in FIGS. 1-12. In accordance with the purposes of this invention, as embodied and broadly described herein, this invention, in one aspect, relates to an electrical connector assembly with an electrical connector.

In an electrical connector 100 according to certain embodiments of the present invention, a left-right direction is defined as the X-axis, where a leftward direction is the positive direction of the X-axis; a front-rear direction is defined as the Y-axis, where a forward direction is the positive direction of the Y-axis; and a vertical direction is defined as the Z-axis, where an upward direction is the positive direction of the Z-axis.

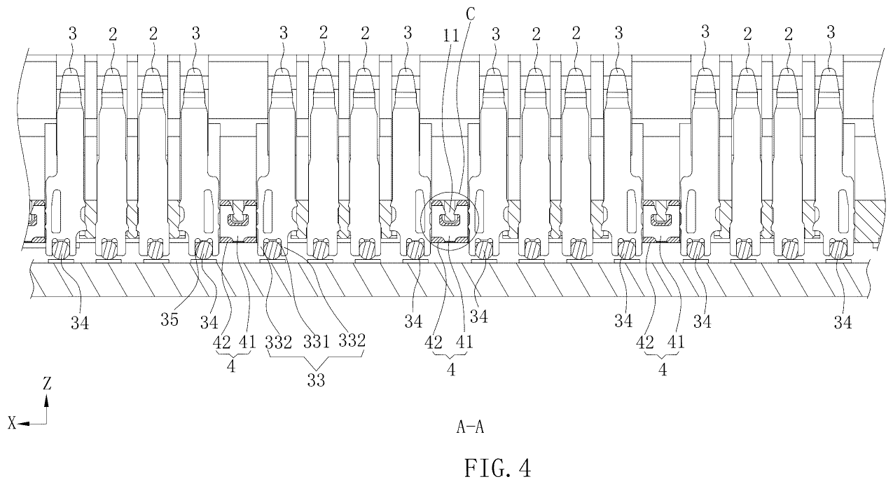

Referring to FIG. 1, the electrical connector 100 according to the present invention includes an insulating body 1, a plurality of terminals and a plurality of insertion assemblies 4. The terminals at least include two signal terminals 2 and two ground terminals 3 arranged along the left-right direction, and the two ground terminals 3 are adjacent to each other. That is, the signal terminals 2 and the ground terminals 3 are arranged in a sequential order of-S-S-G-G-S-S-G-G-. Each insertion assembly 4 is located between the two adjacent ground terminals 3. The signal terminals, the ground terminals and the insertion assemblies are assembled and fixed to the insulating body, and the signal terminals and the ground terminals are soldered downward to a circuit board. Referring to FIG. 1 and FIG. 4, each terminal includes a soldering portion 33 and a strip connecting portion 35. The soldering portion 33 includes a notch 331 and soldering legs 332 located at a left side and a right side of the notch 331, and the soldering legs 332 are soldered downward to the circuit board. The strip connecting portion 35 protrudes downward into the notch 331, and a bottom portion of the strip connecting portion 35 is higher than a bottom portion of each soldering leg 332. A solder ball 34 is accommodated in the notch 331, and the strip connecting portion 35 abuts against the solder ball 34 such that the solder ball 34 passes downward beyond the bottom portion of each soldering legs 332, thereby being convenient for the subsequent soldering process. The strip connecting portion 35 of each terminal is a portion connected to the strip, and when the strip is cut, the strip connecting portion 35 often has barbs thereon. By designing the bottom portion of the strip connecting portion 35 to be higher than the bottom portion of each soldering leg 332, the strip connecting portion 35 is not connected to the circuit board. Thus, the barbs on the strip connecting portion 35 does not affect the soldering of the terminals.

In the first embodiment of the present invention, each insertion assembly 4 includes a metal sheet 41 and an insulating block 42 fixed to the metal sheet 41. The material of the insulating block 42 is a wave absorbing material and is integrally insert-molded to the metal sheet 41.

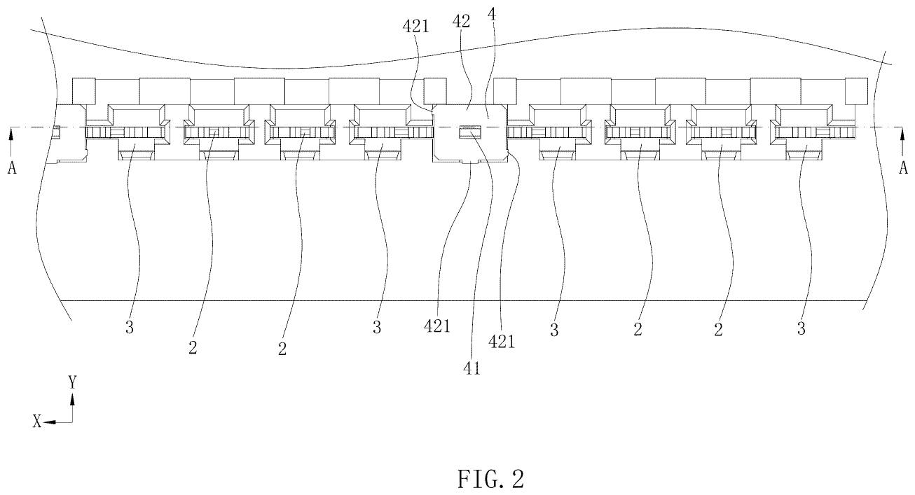

Referring to FIG. 2, along the front-rear direction, a thickness of the insulating block 42 is greater than a thickness of each ground terminal 3. The insulating block 42 has two side surfaces opposite to each other along the left-right direction. Each side surface is protrudingly provided with a protruding block 421, and the protruding block 421 abuts against and interferes with the insulating body 1. Further, a rear side surface of the insulating block 42 also has a protruding block 421 which abuts against and interferes with the insulating body 1. Each insulating block 42 interferes with the insulating body 1 by three protruding blocks 421 located on three different side surfaces, thereby being firmly fixed to the insulating body 1 without easily getting loosened.

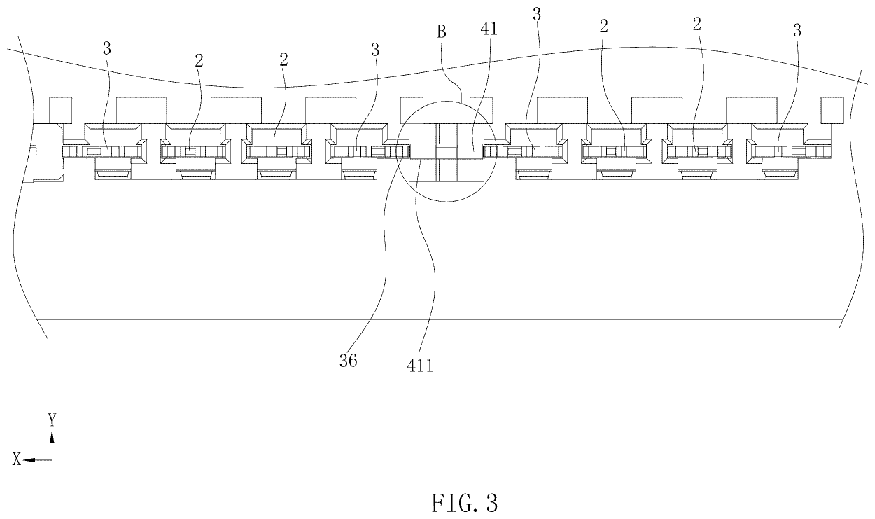

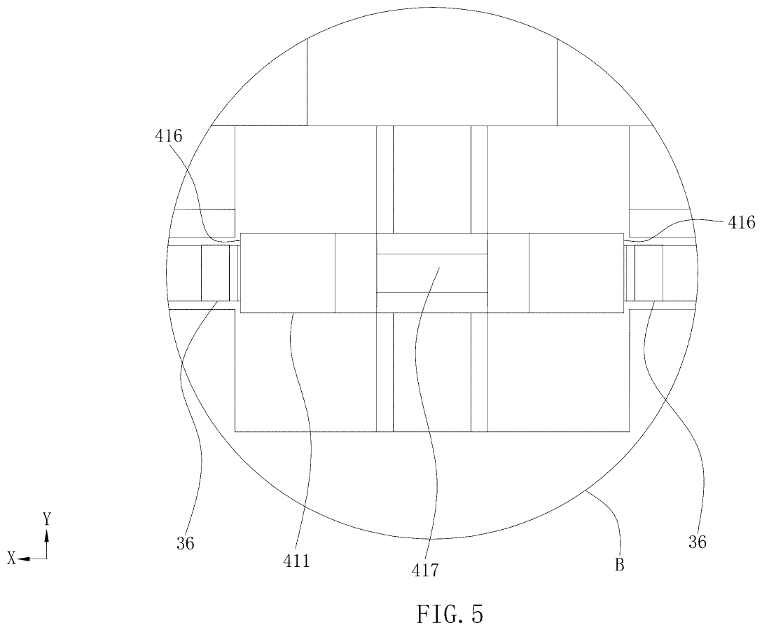

Referring to FIG. 3 and FIG. 5, the metal sheet 41 is electrically connected to the two ground terminals 3. The metal sheet 41 and the ground terminals 3 are in plate shapes, and plate surfaces of the metal sheet 41 and the ground terminals 3 are parallel to each other. Considering the actual manufacturing tolerance errors, the term “parallel” as herein used refers to an included angle between the plate surface of the metal sheet 41 and the plate surface of each ground terminal 3 being less than 10 degrees. Further, in a direction perpendicular to a rear plate surface 411 of the metal sheet 41, a distance of a rear plate surface 36 of each ground terminal 3 passing beyond the rear plate surface 411 of the metal sheet 41 is less than twice the thickness of each of the ground terminals 3, or a distance of the rear plate surface 411 of the metal sheet 41 passing beyond the rear plate surface 36 of each ground terminal 3 is less than twice the thickness of each of the ground terminals 3, or the rear plate surface 411 of the metal sheet 41 and the rear plate surface 36 of each ground terminal 3 are flush.

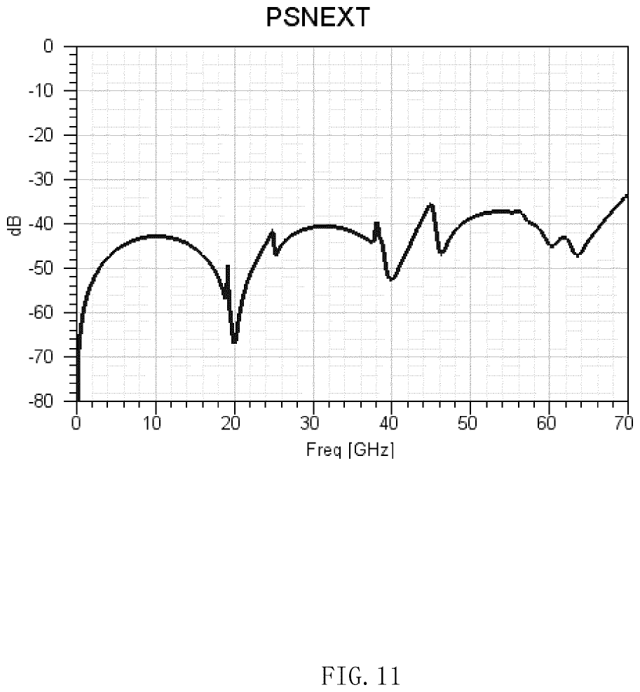

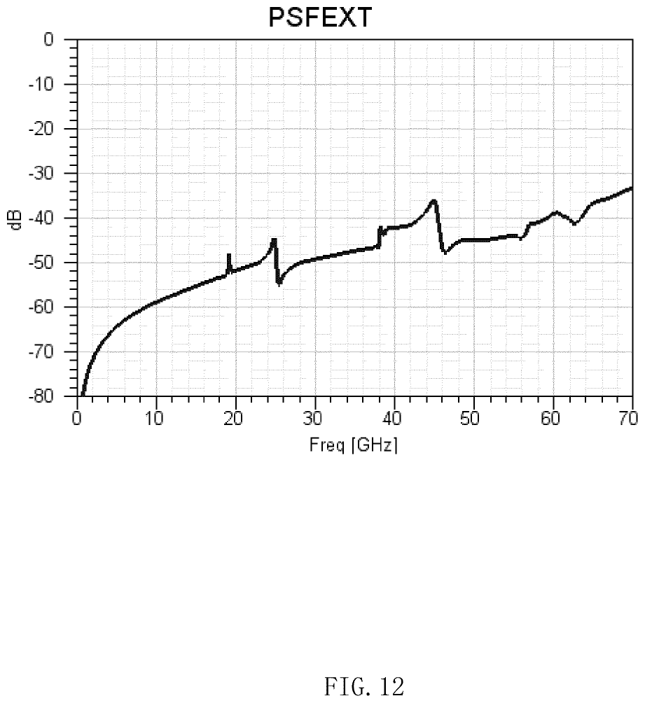

In the present embodiment, a thickness of each ground terminal 3 is 0.1 mm, and the distance of the rear plate surface 411 of the metal sheet 41 passing beyond the rear plate surface 36 of each ground terminal 3 is 0.02 mm. Referring to the charts of high frequency analysis of near end crosstalk and far end crosstalk in FIG. 11 and FIG. 12, it may be observed that, before the transmission frequency reaches 40 GHz, both the near end crosstalk and the far end crosstalk do not exceed-40 dB, and the high frequency characteristics are excellent. In other embodiments, the thickness of the metal sheet 41 may be 0.08 mm, allowing the rear plate surface 36 of each ground terminal 3 to pass beyond the rear plate surface 411 of the metal sheet 41. Alternatively, the thickness of the metal sheet 41 may be 0.1 mm, allowing the rear plate surface 411 of the metal sheet 41 and the rear plate surface 36 of each ground terminal 3 to be flush. It is also possible that the thickness of the metal sheet 41 is greater than 0.1 mm, but the thickness of the metal sheet 41 is less than its width, and the thickness of the metal sheet 41 is less than 0.5 mm, such that the distance of the rear plate surface 411 of the metal sheet 41 passing beyond the rear plate surface 36 of each ground terminal 3 is less than twice the thickness of each of the ground terminals 3.

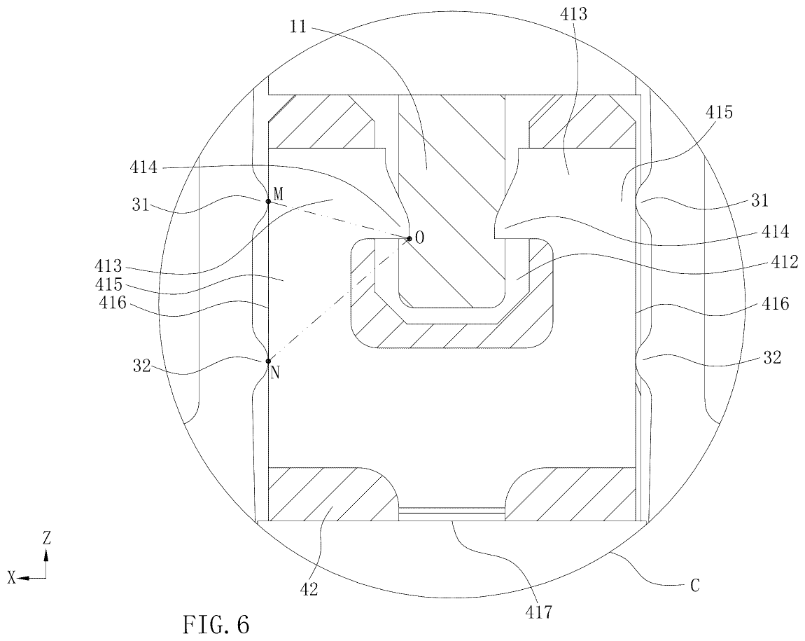

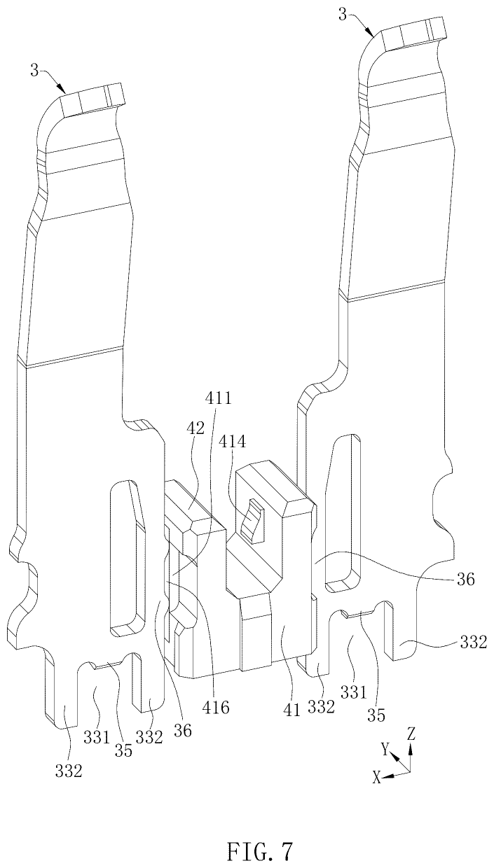

Referring to FIG. 6 and FIG. 7, the metal sheet 41 is provided with an opening slot 412 and two retaining arms 413. The two retaining arms 413 are respectively located at a left side and a right side of the opening slot 412. The insulating body 1 has a protruding rib 11, and the protruding rib 11 is accommodated in the opening slot 412 and interferes with the two retaining arms 413. Each retaining arm 413 includes an abutting portion 415 and an interference portion 414 located at a left side and a right side thereof.

Along the left-right direction, the abutting portion 415 abuts against a corresponding ground terminal 3, and the interference portion 414 abuts against the protruding rib 11. In other words, each retaining arm 413 is clamped between the corresponding ground terminal 3 and the protruding rib 11.

The abutting portion 415 includes an abutting surface 416 and the rear plate surface 411 of the metal sheet 41 perpendicular to and connected to the abutting surface 416. Each ground terminal 3 includes an upper protruding portion 31 and a lower protruding portion 32, and elastic slots, which may generate elastic deformation, are formed at one side of the upper protruding portion 31 and the lower protruding portion 32, such that the upper protruding portion 31 and the lower protruding portion 32 elastically abut against the abutting surface 416. Further, the upper protruding portion 31 is located above the interference portion 414, and the lower protruding portion 32 is located below the interference portion 414. For each retaining arm 413, a first contact point O exists between the interference portion 414 and the protruding rib 11, a second contact point M exists between the abutting surface 416 and the upper protruding portion 31, and a third contact point N exists between the abutting surface 416 and the lower protruding portion 32. The three contact points form a triangle, such that the interference fixing between the retaining arm 413 and the corresponding ground terminal 3 and the protruding rib 11 is firm.

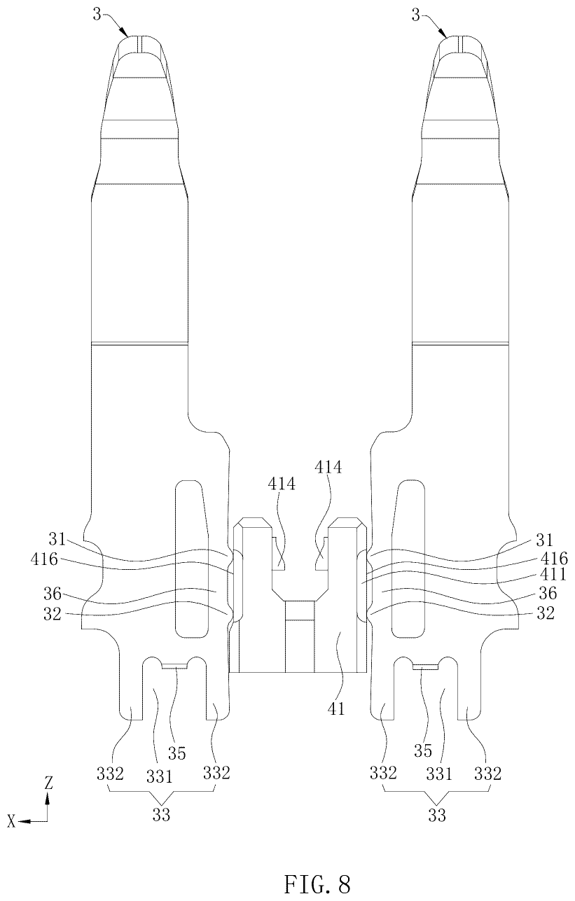

When the insulating block 42 is insert-molded to the metal sheet 41, to ensure the abutting of the abutting surface 416 and the corresponding ground terminal 3, the abutting surface 416 must be exposed out of the insulating block 42, thereby requiring a mold component to stop the wave absorbing material from shielding the abutting surface 416 during the insert-molding process. Referring to FIG. 8, a portion of the rear plate surface 411 of the metal sheet 41 connected to the abutting surface 416 is exposed from the insulating block 42, and the mold component may be fixed at this position to stop the wave absorbing material, thus ensuring the abutting surface 416 to be exposed out of the insulating block 42 and to abut against the corresponding ground terminal 3.

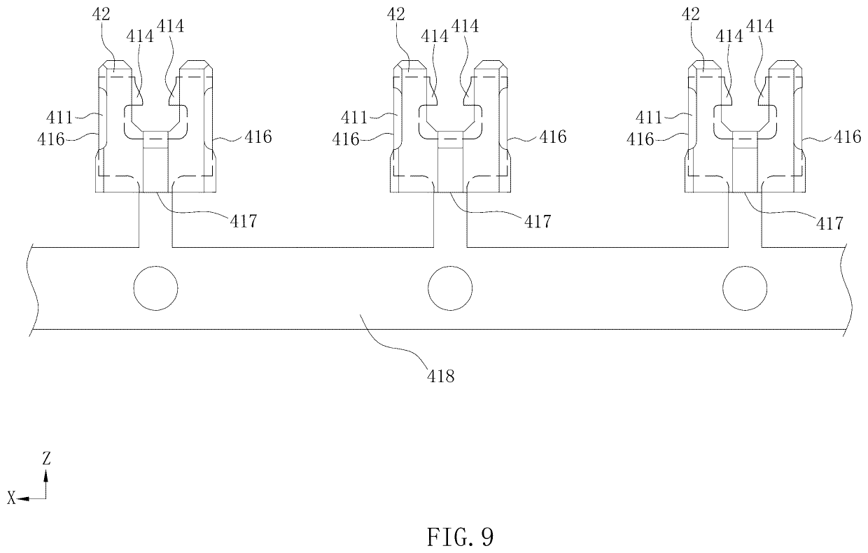

Referring to FIG. 9, the metal sheet 41 further includes a connecting portion 417 exposed out of the insulating block 42. When insert-molding the insulating block 42, the connecting portion 417 is connected to a connecting member 418, and the connecting member 418 is connected to the connecting portions 417 of the insertion assemblies 4. Thus, during the assembly of the insertion assemblies 4, the insertion assemblies 4 may be simultaneously assembled by a connecting member 418.

In sum, the first embodiment of the present invention has the following beneficial effects:

The metal sheet 41 and the two ground terminals 3 are electrically connected, and the plate surface of the metal sheet 41 and the plate surfaces of the ground terminals 3 are parallel to each other. Normally, a metal member has its thickness to be less than its width. Thus, compared to the case where the plate surface of the metal sheet 41 is perpendicular to the plate surfaces of the ground terminals 3, in the first embodiment of the present invention, when the current flows from one ground terminal 3 to the other ground terminal 3, the stub generated is shorter, and the high frequency characteristics become better.

On the other hand, the insulating block 42 includes the wave absorbing material, which covers outside the metal sheet 41, thus absorbing the noise and reducing the crosstalk between the signal terminals 2, and by making the insulating block 42 thicker, the cross-sections of the whole insertion assemblies 4 perpendicular to the insertion direction are increased, thereby allowing the opening of each slot accommodating the corresponding insertion assembly 4 to become larger, which is convenient to the assembly of the insertion assemblies 4. During assembly, the protruding blocks 421 on the two side surfaces of the insulating block 42 in the left-right direction may abut against and be fixed to the insulating body 1, and the whole insertion assemblies 4 do not easily get loosened. More suitably, since the insulating block 42 is not electrically conductive, it does not generate the stub when it becomes thicker.

In the present embodiment, during assembly, the insertion assemblies are firstly assembled, and then the ground terminals and the signal terminals are inserted, such that after the insertion assemblies are assembled, the connecting portions 417 and the connecting member may be cut simultaneously, and by the interference between the interference portions 414 of the metal sheet 41 and the protruding rib 11 and the interference between the protruding blocks 421 of the insulating block 42 and the insulating body 1, each insertion assembly 4 may be firmly fixed in the insulating body 1, and during the subsequent assembly, the ground terminals 3 may be elastically abut against the metal sheet 41 accurately, thus resulting in a higher yield.

For the aforementioned structures, in other embodiments, it is also possible to replace the insulating block 42 by a conductive plastic. Compared to the related art, the crosstalk between the signal terminals may be reduced.

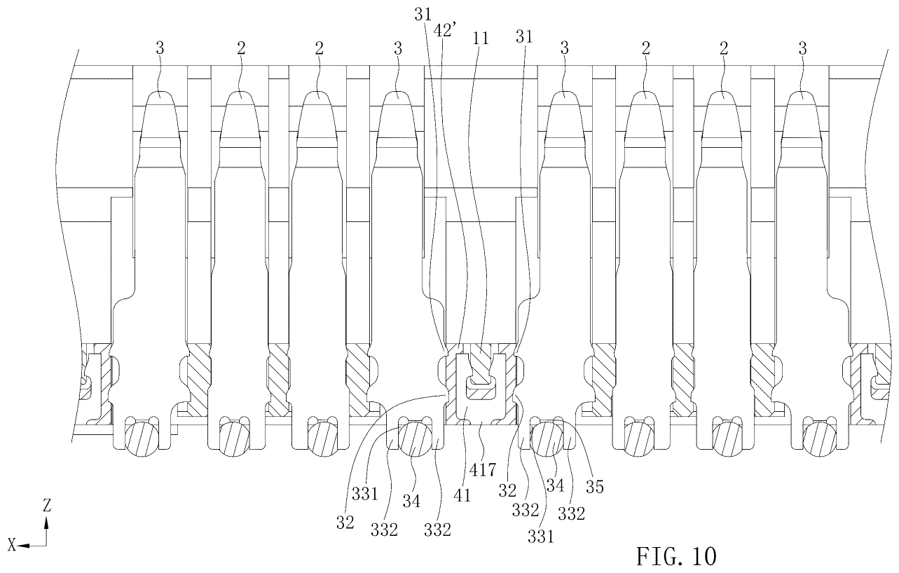

Referring to FIG. 10, the second embodiment of the present invention is different from the first embodiment in that the metal sheet 41 does not abut against the ground terminals 3. In other words, the two adjacent ground terminals 3 are not electrically connected by the metal sheet 41. The insulating block 42 is completely formed by the wave absorbing material, and the two side surfaces at the left side and the right side of the metal sheet 41 are covered by the wave absorbing material. Thus, when the wave absorbing material is insert-molded on the metal sheet 41, there is no need for an additional mold to be fixed on the metal sheet 41, further saving the cost.

The wave absorbing material, by relying on its characteristics, is provided between the ground terminals 3, thus absorbing the noise, reducing the crosstalk between the signal terminals 2, and improving the high frequency characteristics of the electrical connector 100. On one hand, the metal sheet 41 is provided as a shielding sheet, and on the other hand, the insertion assemblies 4 may be connected to the connecting member by the connecting portions 417 of the metal sheets 41. Thus, by operating the connecting member, the insertion assemblies 4 may be simultaneously assembled.

Also referring to FIG. 10, the third embodiment of the present invention is different from the first embodiment in that each insertion assembly 4 includes a metal sheet 41 and a lossy member 42′ retained on the metal sheet 41. The lossy member 42′ is made of a conductive plastic. In each insertion assembly 4 according to the present embodiment, the conductive plastic may be insert-molded on the metal sheet 41, or the metal sheet 41 may be assembled and fixed to the conductive plastic.

Further, similar to the second embodiment, the metal sheet 41 does not abut against the ground terminals 3. The two ground terminals 3 are electrically connected by the conductive plastic therebetween, and the conductive plastics of the insertion assemblies 4 are isolated from each other without being electrically connected.

The benefits of the third embodiment of the present invention exist in that the conductivity of the conductive plastic is relatively low, and the conductive plastic is a lossy material, which has certain effects of absorbing the noise, such that when it abuts against the corresponding ground terminal 3, even though the stub is generated, the effect is relatively smaller compared to case where the metal sheet 41 is used. Further, by additionally providing the metal sheet 41 without abutting against the ground terminals 3, the overall conductive characteristics of the conductive plastic are strengthened without affecting the conductivity between the conductive plastic and the abutting portion 415 of the corresponding ground terminal 3, and the metal sheet 41 provided may be similar to that in the first embodiment to be convenient for the assembly of the insertion assemblies 4.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body;
a plurality of terminals, accommodated in the insulating body along a vertical direction, wherein the terminals comprise two signal terminals and two ground terminals arranged along a left-right direction, the two ground terminals are adjacent to each other, and the two ground terminals are located between the two signal terminals; and
a plurality of insertion assemblies, wherein each of the insertion assemblies is located between the two ground terminals, each of the insertion assemblies comprises a metal sheet and an insulating block fixing the metal sheet, the metal sheet is electrically connected to the two ground terminals, the metal sheet and the ground terminals are in plate shapes, and plate surfaces of the metal sheet and the ground terminals are parallel to each other, the insulating block comprises a wave absorbing material, in a direction perpendicular to the plate surfaces of the ground terminals, a thickness of the insulating block is greater than a thickness of each of the ground terminals, and two side surfaces of the insulating block opposite to each other along the left-right direction abut against the insulating body.

2. The electrical connector according to claim 1, wherein in a direction perpendicular to a rear plate surface of the metal sheet, a distance of a rear plate surface of each of the ground terminals passing beyond the rear plate surface of the metal sheet is less than twice the thickness of each of the ground terminals, or a distance of the rear plate surface of the metal sheet passing beyond the rear plate surface of each of the ground terminals is less than twice the thickness of each of the ground terminals, or the rear plate surface of the metal sheet and the rear plate surface of each of the ground terminals are flush.

3. The electrical connector according to claim 1, wherein the metal sheet is provided with an opening slot and two interference portions, the two interference portions are respectively located at two sides of the opening slot, the insulating body has a protruding rib, and the protruding rib is accommodated in the opening slot and interferes with the interference portions.

4. The electrical connector according to claim 3, wherein the metal sheet comprises two retaining arms located at a left side and a right side thereof, each of the retaining arms comprises an abutting portion and a corresponding one of the interference portions located at a left side and a right side thereof, the abutting portion abuts against a corresponding one of the ground terminals, and the interference portions abut against the protruding rib.

5. The electrical connector according to claim 4, wherein each of the ground terminals comprises an upper protruding portion and a lower protruding portion, the upper protruding portion and the lower protruding portion respectively abut against the abutting portion, the upper protruding portion is located above the interference portions, and the lower protruding portion is located below the interference portions.

6. The electrical connector according to claim 1, wherein the insulating block is insert-molded to the metal sheet, the metal sheet comprises two abutting portions located at a left side and a right side thereof, each of the abutting portions comprises an abutting surface and a rear plate surface of the metal sheet perpendicular to and connected to the abutting surface, the abutting surface abuts against a corresponding one of the ground terminals, and a portion of the rear plate surface of the metal sheet connected to the abutting surface is exposed from the insulating block.

7. The electrical connector according to claim 1, wherein the metal sheet comprises a connecting portion exposed out of the insulating block, and the insertion assemblies are simultaneously assembled by a connecting member connected to the connecting portion.

8. The electrical connector according to claim 1, wherein each of the terminals comprises a soldering portion and a strip connecting portion, the soldering portion comprises a notch and soldering legs located at a left side and a right side of the notch, the soldering legs are soldered downward to a circuit board, the strip connecting portion protrudes downward into the notch, a bottom portion of the strip connecting portion is higher than a bottom portion of each of the soldering legs, a solder ball is accommodated in the notch, and the strip connecting portion abuts against the solder ball such that the solder ball passes downward beyond the bottom portion of each of the soldering legs.

9. An electrical connector, comprising:
an insulating body;
a plurality of terminals, accommodated in the insulating body, wherein the terminals are arranged in at least two rows along a front-rear direction, the terminals in each of the rows comprise two signal terminals and two ground terminals arranged along a left-right direction, the two ground terminals are adjacent to each other, and the two ground terminals are located between the two signal terminals; and
a plurality of insertion assemblies separated from each other, accommodated in the insulating body, wherein each of the insertion assemblies is located between the two ground terminals and abuts against the two ground terminals, each of the insertion assemblies comprises a metal sheet and a lossy member fixed on the metal sheet, a thickness of each of the insertion assemblies is greater than a thickness of each of the ground terminals, and two side surfaces of each of the insertion assemblies opposite to each other along the left-right direction abut against the insulating body.

10. The electrical connector according to claim 9, wherein the metal sheet comprises a connecting portion exposed out of the lossy member, and the insertion assemblies are simultaneously assembled by a connecting member connected to the connecting portion.

11. The electrical connector according to claim 9, wherein the metal sheet is provided with an opening slot and two interference portions, the two interference portions are respectively located at two sides of the opening slot, the insulating body has a protruding rib, and the protruding rib is accommodated in the opening slot and interferes with the interference portions.

12. The electrical connector according to claim 12, wherein the metal sheet comprises two retaining arms located at a left side and a right side thereof, each of the retaining arms comprises an abutting portion and a corresponding one of the interference portions located at a left side and a right side thereof, the interference portions abut against the protruding rib, the abutting portion comprises an abutting surface and a rear plate surface of the metal sheet perpendicular to and connected to the abutting surface, each of the ground terminals comprises an upper protruding portion and a lower protruding portion, the upper protruding portion and the lower protruding portion respectively abut against the abutting portion, the upper protruding portion is located above the interference portions, and the lower protruding portion is located below the interference portions.

13. The electrical connector according to claim 9, wherein the lossy member is insert-molded to the metal sheet, the metal sheet comprises two abutting portions located at a left side and a right side thereof, each of the abutting portions comprises an abutting surface and a rear plate surface of the metal sheet perpendicular to and connected to the abutting surface, the abutting surface abuts against a corresponding one of the ground terminals, and a portion of the rear plate surface of the metal sheet connected to the abutting surface is exposed from the lossy member.

14. An electrical connector, comprising:
an insulating body;
a plurality of terminals, accommodated in the insulating body along a vertical direction, wherein the terminals comprise two signal terminals and two ground terminals arranged along a left-right direction, the two ground terminals are adjacent to each other, and the two ground terminals are located between the two signal terminals; and
a plurality of insertion assemblies, located between the two ground terminals, wherein each of the insertion assemblies comprises a metal sheet and an insulating block fixing the metal sheet, in a direction perpendicular to plate surfaces of the ground terminals, a thickness of the insulating block is greater than a thickness of each of the ground terminals, two side surfaces of the insulating block opposite to each other along the left-right direction abut against the insulating body, the metal sheet abuts against the two ground terminals, the metal sheet and the ground terminals are in plate shapes, and in a direction perpendicular to a rear plate surface of the metal sheet, a distance of a rear plate surface of each of the ground terminals passing beyond the rear plate surface of the metal sheet is less than twice the thickness of each of the ground terminals, or a distance of the rear plate surface of the metal sheet passing beyond the rear plate surface of each of the ground terminals is less than twice the thickness of each of the ground terminals, or the rear plate surface of the metal sheet and the rear plate surface of each of the ground terminals are flush.
